(19) United States
(12) Patent Application Publication
(10) Pub. No.: US 2010/0106646 A1
(43) Pub. Date: Apr. 29, 2010

(54) SYSTEM AND METHOD FOR ASSET IDENTIFICATION, EVALUATION, AND CONTROL

(76) Inventors: STACY M. PASSERI, DANVILLE, CA (US); BHARAT C. PORIA, MORGAN HILL, CA (US)

Correspondence Address: LAW OFFICES OF CHARLES L. THOEMING;BIELEN, LAMPE & THOEMING, P.A., TWO CORPORATE CENTRE 1390 WILLOW PASS ROAD, SUITE 1020, CONCORD, CA, 94520, US

(21) Appl. No.: 12/603,827

(22) Filed: Oct. 22, 2009

Related U.S. Application Data
(60) Provisional application No. 61/107,777, filed on Oct. 23, 2008.

(51) Int. Cl. G06Q 40/00; H04L 9/32; H04L 9/00; G09C 3/08

(52) U.S. Cl. 705/50; 726/27; 380/51

(57) ABSTRACT

A system and method for data identification, evaluation and control includes pass code and vaulting of consumer information. A non-disclosure process for encrypted records barcode review for underwriters and annual auditors offers unique year end validation for shareholders, regulators, and governmental oversight. The method and system also provides technology useful in fraud detection and asset protection by identifying underwriting patterns through database audit. An embodiment for financial information containing the credit worthiness of a payer on a debt instrument, current valuation of an asset to which the debt instrument is collateralized, and a revalidation of title for the asset as necessary for secondary market financing, trading and asset valuation is disclosed.

### CROSS-REFERENCES TO RELATED APPLICATIONS

This United States non-provisional patent application is based upon and claims the filing date of U.S. provisional patent application Ser. No. 61/107,777 filed Oct. 23, 2008.

### STATEMENT REGARDING FEDERALLY SPONSORED RESEARCH OR DEVELOPMENT

None.

### REFERENCE TO A MICRO-FICHE APPENDIX

None.

### TECHNICAL FIELD

This invention relates to methods and systems for financial recordkeeping. More particularly, the invention relates to a secure and private method and system for asset identification, evaluation and control. An embodiment discloses an updatable financial information data file containing the credit worthiness of the payer on a debt instrument, current valuation of the asset to which the debt instrument is collateralized, and the revalidation of title particularly useful in secondary market financing, trading, and asset valuation.

### DISCLOSURE OF INVENTION

Present debt instrument creation and underwriting methods classify the debt as to “paper quality” and not underwriting quality. As presently practiced, lenders/originators are motivated to sell the debt instrument to a secondary market to create liquidity in the lender/originator's portfolio. In such circumstance, the mark-to-market or mark-to-model (during distressed market environments) positions in the trading book receive immediate attention; however, the assets are not transparent with current collateral values or borrower status. Portfolio limits are set on each rating category, but trading desks are left to their own devices for determining the quality of the debt being carried or offered. Thus, illiquid loans are accounted for on an accrual basis in the “banking book” rather than on a mark-to market basis in the trading book. With increased volume and complexity of the secondary market debt trades, many underwriters avoid the rigorous credit processes applied to the banking-book assets, giving rise to a massive failure to identify some of the weaknesses inherent in such instruments. Although many lenders in the financial services industry have systems to recognize non-performing debt, those processes do not adequately identify quality loans versus high risk loans until an irreversible default crises occurs within the industry. At that time, most attention is focused on backwards remedies instead of solving the underlying problem of providing secure and transparent means to identify and evaluate asset value throughout the life of the debt instrument.

Recent announcements by authorities in various countries recognize the need to deal with problem assets and assess banks' resilience to the further deteriorating global economy in order to determine recapitalization needs. This crisis has spread to emerging markets with the collapse of international financing. Since valuation issues remain an important source of uncertainty, governments need to establish methodologies for the realistic valuation of illiquid, securitized credit instruments. The challenge then, is the unwinding of toxic assets tied up in complex instruments in an orderly fashion that maximizes value, while creating and regulating new markets for buying and selling complex financial instruments, enabling transactions to proceed again at some market-clearing price. There is a pressing need to create a new framework to separate valuable and poor-performing assets from convoluted pools of mortgage-backed securities that panicked markets have written off as toxic.

During the unraveling of the economic crisis, one great contributing factor to the opacity of the tremendous risk was a widely held practice and bookkeeping device used by financial companies and banking institutions. This practice, originally intended to ease certain accounting functions, inappropriately allowed them to park hundreds of billions of dollars in loans in their off-balance-sheet trusts known as qualified special-purpose entities, or (“QSPEs”), as a generally accepted accounting principle. The lack of disclosure of these off-balance-sheet transactions and absence of capital supporting ballooning subprime mortgage loans in the off-balance-sheet transactions aggravated the massive losses sustained by banks and financial companies as the housing market collapsed. The lenders made profits in the run-up to the subprime mortgage crisis by selling pools of loans to off-balance-sheet trusts. These off-balance-sheet trusts were repackaged into pools of mortgage-backed securities and collateralized debt obligations securities, and marketed globally. This off-balance-sheet process afforded tremendous leverage with regard to the financial institutions capital deposit requirements thereby generating massive profits with little accountability, now resulting in bankruptcies, bailouts and a collapse of the marketplace. The final result has been foreclosures, bankruptcies and bailouts all on the backs of the taxpayer.

The United States Treasury would like to establish a comprehensive regulatory framework for over-the-counter derivatives, which under current law are mostly excluded and exempted from regulation. The Treasury would further seek to amend the Commodity Exchange Act, securities laws and other laws to achieve the following: 1) prevent activities in those markets from posing risk to the financial system; 2) promote the efficiency and transparency of those markets; 3) prevent market manipulation, fraud and other market abuses; and 4) insure that the over-the-counter (“OTC”) derivatives are not marketed inappropriately to unsophisticated parties.

There is a present need for a system and method that provides transparency and accountability directed towards a perpetual underwriting process to validate the borrower's ability to pay and the real and current value of the underlying asset rather than categorizing the debt instrument as filtered through a lender's perspective, which often presents inherent conflict of interest as to the current quality of the debt instrument. As these loans are bundled and re-sold in secondary markets, the current underwriting status of the borrower is unknown, the real value of the property securing the debt is not known, and the true ability of the borrower to repay the original loan is not known. All loans are purchased and bundled without regard to the nature of the underwriting that supported the initial decision to make the original loan.

The result of this current practice is an unidentifiable inventory as to the true credit worthiness of the underlying debt instruments. Since there is no present method to ascertain the value and true credit worthiness of a debt instrument, it is not possible to adequately value a bundled portfolio of these debt instruments. The present valuation process for these types of debt instruments is made more difficult by the fact that most instruments are no longer with the originator/lender and/or the borrower is no longer doing business with the originator/lender.

There is presently a need for a consumer friendly encrypted records barcode based method and system for authenticating entities to identify, evaluate, and control assets. Such a method and system includes pass code and vaulting of consumer information. The system and method would further provide a non-disclosure process for encrypted records barcode review for underwriters and annual auditors for unique year end validation for shareholders, regulators, and governmental oversight. The method and system also provide technology useful in fraud detection and protection by identifying underwriting patterns through database audit.

It is therefore an objective of the system and method for asset identification, evaluation and control to provide a secure and private record of the credit worthiness of the payer on a debt instrument, current valuation of the asset to which the debt instrument is collateralized, and the revalidation of title attached to the debt instrument.

It is a further objective of the system and method for asset identification, evaluation and control to efficiently and effectively stop fraud before loans are submitted by the broker, funded by the lender, and/or purchased by the secondary market.

Still another objective of the system and method for asset identification, evaluation and control is to provide real time loan information, risk management and identification appended in digital read/write format to the debt instrument.

A further objective of the system and method for asset identification, evaluation and control is to provide integrated credit worthiness of the payer on a debt instrument, current valuation of the asset to which the debt instrument is collateralized, and the revalidation of title across numerous sources and transformed to create a single master copy of the data in encrypted digital format appended to the relevant debt instrument.

Another objective of the system and method for asset identification, evaluation and control is to provide modularly upgraded loan data within an information infrastructure appended to a debt instrument for use by consumers as investors, regulators, mortgage brokers, mortgage bankers, lenders, and auditors.

Other features, advantages, and objects of the system and method for exception based management of dynamic events will become apparent with reference to the following description and accompanying drawings.

These together with other objects of the system and method for asset identification, evaluation and control, along with the various features of novelty that characterize the invention, are described with particularity in the specification attached to and forming a part of this disclosure. For a better understanding of the system and method for asset identification, evaluation and control, the operating advantages thereof and the specific objects thereby attained by the use thereof, reference should be made to the attached drawings and descriptive materials in which there are illustrated preferred embodiments of the invention.

### BRIEF DESCRIPTION OF DRAWINGS

These and other features, aspects, and advantages of the system and method for asset identification, evaluation and control will become better understood with regard to the following description, appended claims, and accompanying drawings as further described.

FIG. 1 is a process diagram 100 of a turnkey service for loan originations for an embodiment of the system and method for asset identification, evaluation and control.

FIG. 1A is a key for the process diagram function by loan origination participant for an embodiment of the system and method for asset identification, evaluation and control.

FIG. 2 is a process diagram 200 of a turnkey service for loan origination borrower processes for an embodiment of the system and method for asset identification, evaluation and control.

FIG. 3 is a process diagram 300 of a turnkey service for loan origination underwriter processes for an embodiment of the system and method for asset identification, evaluation and control.

FIG. 4 is a process diagram 400 of a turnkey service for loan origination department of real estate processes for an embodiment of the system and method for asset identification, evaluation and control.

FIG. 5 is a process diagram 500 of a turnkey service for the loan origination audit process for an embodiment of the system and method for asset identification, evaluation and control.

FIG. 6 is a process diagram 600 of a turnkey service for the loan origination emergency services and notifications for an embodiment of the system and method for asset identification, evaluation and control.

FIG. 7 is a process diagram 700 of a turnkey service for the loan origination loan in formation refresh function for an embodiment of the system and method for asset identification, evaluation and control.

FIG. 8A is a partial overview of the barcoded records data file 326H within the loan information library for an embodiment of the method and system for asset identification, evaluation and control of FIGS. 1-7.

FIG. 8B is a partial overview of the loan status data file 710H within the loan information library for an embodiment of the method and system for asset identification, evaluation and control of FIGS. 1-7.

FIG. 8C is a partial overview of the terms of service data file 210H within the loan information library for an embodiment of the method and system for asset identification, evaluation and control of FIGS. 1-7.

FIG. 9A is a partial overview of the scanned loan documents data file 312H within the loan information library for an embodiment of the method and system for asset identification, evaluation and control of FIGS. 1-7.

FIG. 9B is a partial overview of the out-of-norm documents data file 522H within the loan information library of for an embodiment of the method and system for asset identification, evaluation and control of FIGS. 1-7.

FIG. 9C is a partial overview of the anomaly documents data file 510H within the loan information library for an embodiment of the method and system for asset identification, evaluation and control of FIGS. 1-7.

FIG. 9D is a partial overview of the emergency alert data file 232H within the loan information library for an embodiment of the method and system for asset identification, evaluation and control of FIGS. 1-7.

FIG. 10 is a partial overview of block diagram of an exemplary networked system of nodes 10 suitable for use with an embodiment of the method and system for asset identification, evaluation and control of FIGS. 1-9D.

FIG. 11 is a continuation of the partial overview of FIG. 10 of an exemplary networked system of nodes 10 suitable for use with an embodiment of the method and system for asset identification, evaluation and control of FIGS. 1-9D.

### BEST MODE FOR CARRYING OUT THE INVENTION

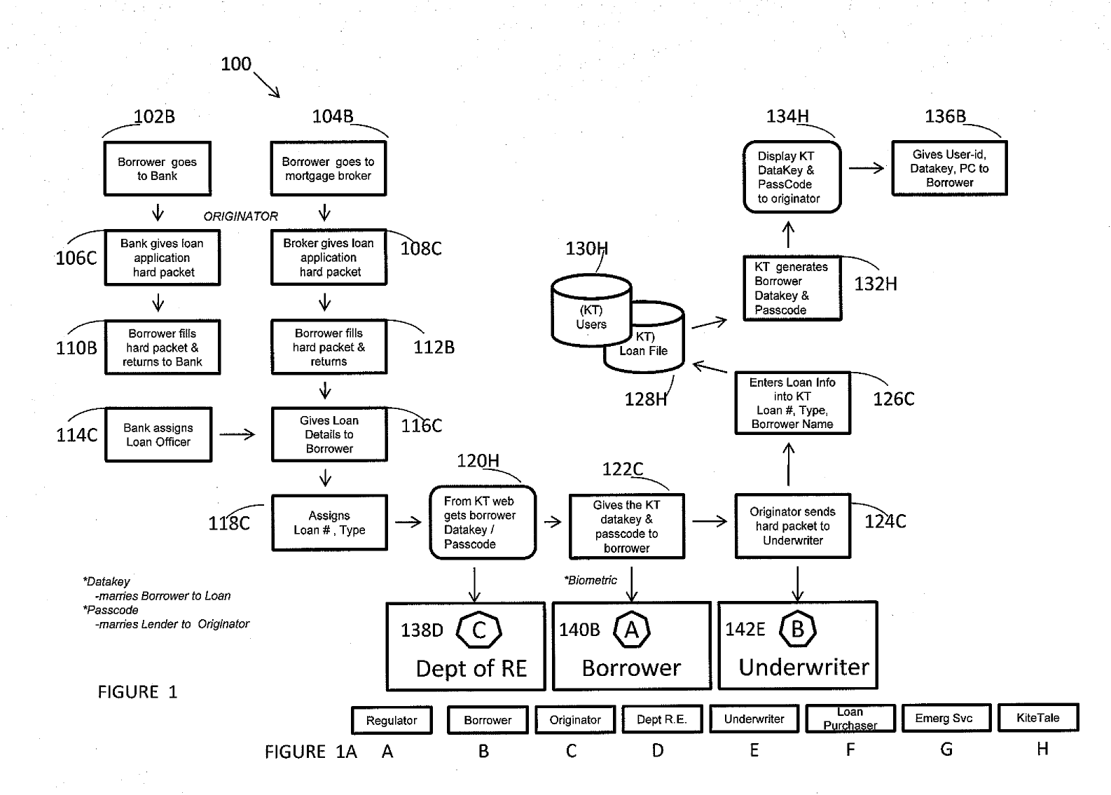

Referring more specifically to the drawings, for illustrative purposes the system and method for asset identification, evaluation and control are embodied generally in nine blocks of methodology as depicted in FIGS. 1-11. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as disclosed and claimed.

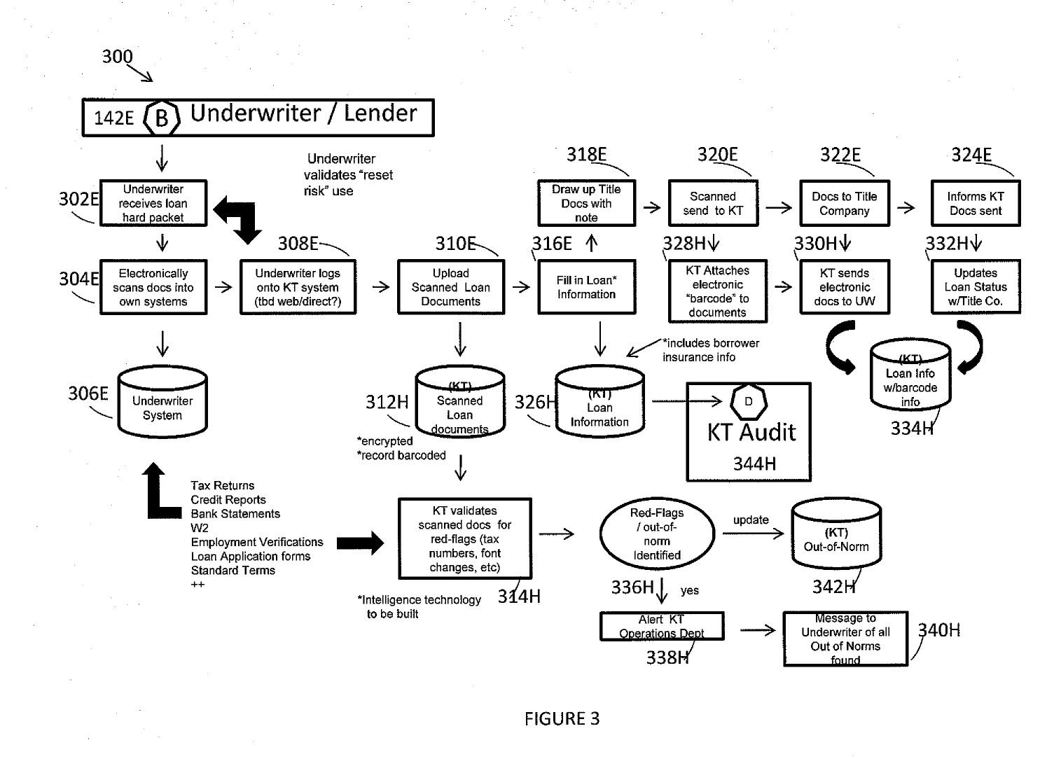

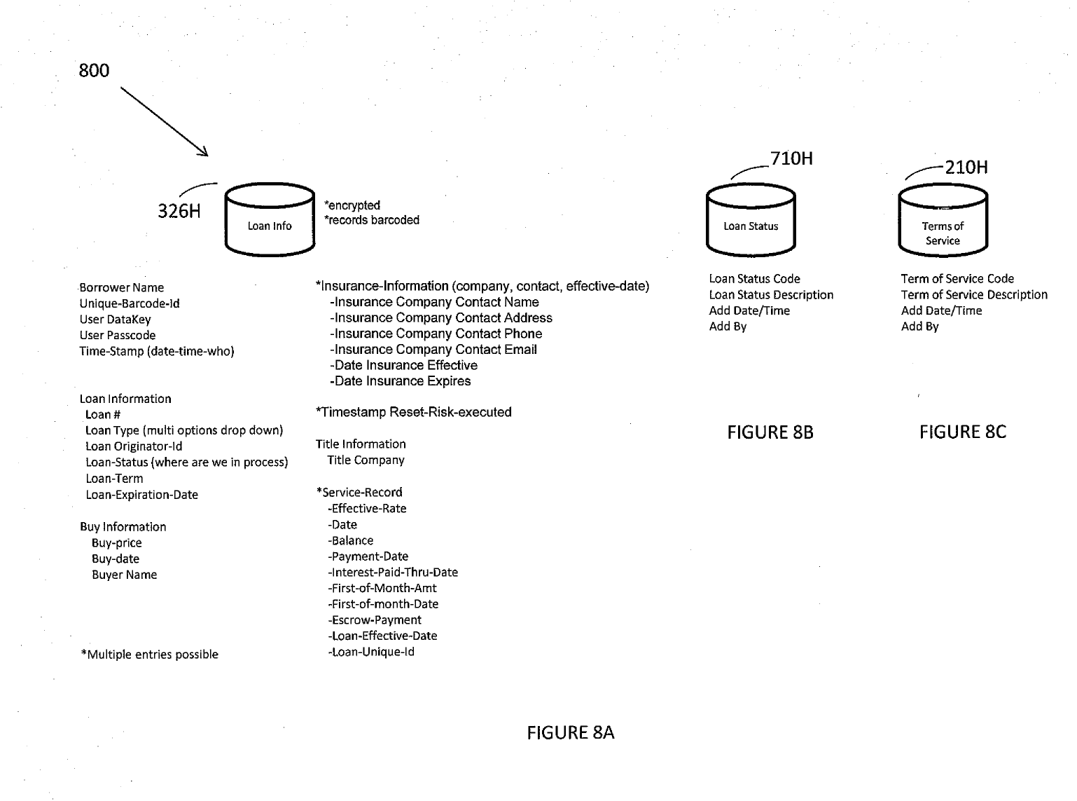

The system includes in combination an encrypted records barcode 328H, FIG. 3, appended to an original signature and notarized debt instrument 328H. A secure software database 326H, FIGS. 3, 8A, provides all authorized users of the system and method access to the data. A secure data key marries the borrower to each particular loan. A secure pass code marries the lender to the loan originator. Unencrypted data is provided with pass code protection and stored in a second data base vault 326, FIGS. 3, 8A.

For the purpose of preventing fraud and not identifying borrower name with the loan and personal details such as borrower's social security identification, monetary value of the loan, and the like, an “encryption key” plus a “data key” will be produced that will be converted to a barcode.

For an embodiment of the system and method for asset identification, evaluation and control, an encryption key identifies the particular unique real estate loan and transaction. The data key uniquely identifies the borrower information. Both keys are generated through an algorithm and may be based on “secret key” and/or “public key” cryptography, both of which employ private encryption keys whose circulation is restricted to one or minimal persons with a need to know basis.

This system and method for asset identification, evaluation and control verifies the authenticity of the encrypted records barcode, as described in greater detail below. Provided a secure encryption process is employed, it becomes extremely difficult to identify a borrower's personal information against loan information, thus maintaining neutrality and security for all parties concerned. Loan and funding decisions can then also be made in total neutrality from borrower identification, affording protection to both the borrower and financial institutions.

Access to borrower personal and loan information only is provided through the use of these keys and via the corresponding barcode. Each time data is updated either from the encryption key, data key, or barcode, any change(s) will be logged and recorded with a date and time stamp, and a corresponding user ID.

The system includes a bar-code communications device or reader 304E, FIG. 3, to read and/or write data from the records barcode 328H, FIG. 3, encrypt the data. For an embodiment of system and method for asset identification, evaluation and control, this data includes the underwriting and borrower qualification requirements as well as software for 1) data validation and authentication, 2) validation or authentication of a source, conduit, or destination of transmitted data, and 3) validation or authentication to read from and/or write to the encrypted records barcode, 328H, FIG. 3.

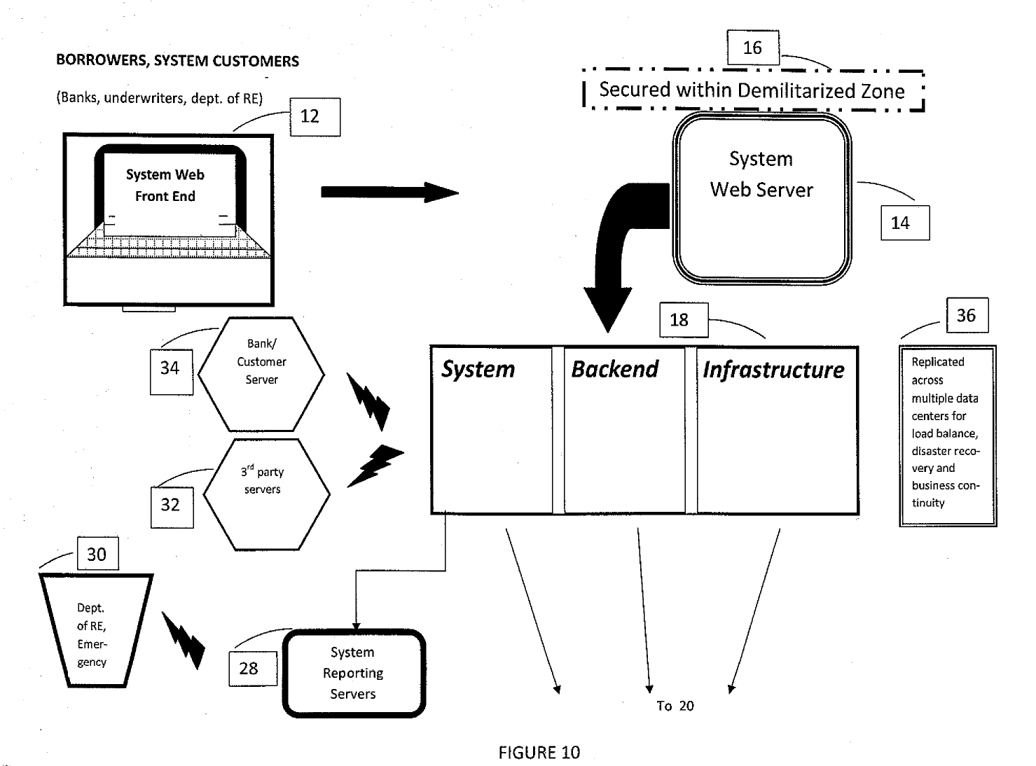

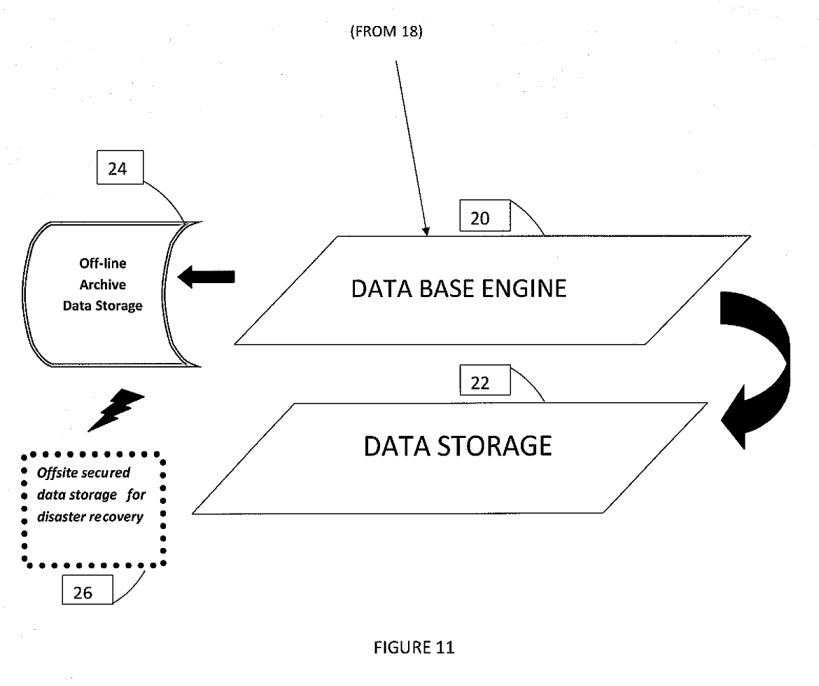

The system 18 includes a telecommunications network with a plurality of third-party or back-up servers/computers 26, 30, 32 and 34 linked thereto, FIGS. 10 and 11. The hardware architecture for the system and method for asset identification, evaluation and control is based on a Linux® platform using Apache®-type servers, with a web front end 12 for consumer and bank access and a specialized secure Class One environment 16. The backend infrastructure 18 will be Unix® based platform utilizing custom applications replicated across multiple data centers for load balance, disaster recovery and business continuity, a database engine 20 and data storage 22 solutions. Various messages and data between and among the system and method for asset identification, evaluation and control, Banks (customers) and participating third parties (i.e. Dept of Real Estate, Edgar) will be routed via custom built application programming interfaces (“APIs”) within the system and method for asset identification, evaluation and control that will populate and update the library structures including, without limitation those data files and/or data system nodes depicted in FIGS. 8A-9D, 10 and 11.

The system backend infrastructure 18 is further supported by direct access to at least one system reporting server 28 and direct access to at least one off-line archive data storage repository 24. At least one off-line archive data storage repository 24 is linked to at least one offsite secured data storage repository 26 by a telecommunications network.

Accordingly, a system for asset identification, evaluation and control, in which selected information for financial information containing (i) the credit worthiness of a payer on a debt instrument, (ii) current valuation of an asset to which the debt instrument is collateralized, (iii) and a revalidation of title for the asset as necessary for secondary market financing, trading and asset valuation is disclosed. The system supports an updatable data set encrypted in combination with information not found in the data set to generate a control access identity. The control identity of the system is provided on selected data set items together with the selected information.

The system for asset identification, evaluation and control includes a scanner for reading the selected information for an updatable data set from an updatable data set hard copy. The system further encrypts the selected information for an updatable data set with (i) an encryption key, plus (ii) a data key. These keys both: (i) are generated through an algorithm based on “secret key” and/or “public key” cryptography; (ii) are converted to a barcode printed on one or more updatable data set hard copies; and (iii) employ private encryption keys whose circulation is restricted to one or minimal persons on a need to know basis.

The system for asset identification, evaluation and control further provides a data processing device, and secret key process using a private key, programmed to (I) digitally format an encrypted updatable data set from an updatable data set hard copy, (ii) read the selected information from the digitally formatted and encrypted updatable data set, (iii) secure the digitally formatted and encrypted updatable data set, (iv) decrypt the control access identity to obtain decrypted selected information from the digitally formatted and encrypted updatable data set, (v) validate the selected information according to set parameters relating to the updatable data set, (vi) update the selected information from the digitally formatted and encrypted updatable data set, (vii) identify each update by date, time and user identity, (viii) re-encrypt the updated selected information, and (ix) re-secure the digitally formatted and re-encrypted updatable data set.

The system for asset identification, evaluation and control further includes telecommunications equipment allowing notification (i) to secured participating third party users of changes to the digitally formatted updatable data set, (ii) to secured participating third party users of variations from set parameters relating to the digitally formatted updatable data set, (iii) from non-secured, non-participating third party users of critical changes to the digitally formatted updatable data set, and (iv) to underwriter and auditor for non-disclosure review of the digitally formatted updatable data set.

These system components are used for the following methodology of an embodiment of the system and method for asset identification, evaluation and control for financial information containing the credit worthiness of a payer on a debt instrument, current valuation of an asset to which the debt instrument is collateralized, and a revalidation of title for the asset as necessary for secondary market financing, trading and asset valuation.

### Block One: Home Loan Origination Block 100 [FIG. 1]

The Home Loan Application process between a lender and a consumer is initiated by a barrower going to a bank or other lending institution 102B or by a borrower going to a mortgage broker 104B. Each reference element terminates with a letter keyed to the respective participant in the loan origination process, FIG. 1A.

The bank or other lending institution or mortgage broker gives the borrower a hard packet loan application, 106C or 108C, respectively. The loan application includes a verification of particular borrower background data including, but not limited to, credit check and employment verification for which the consumer/borrower executes the necessary releases.

The bank assigns a loan officer to the origination transaction 114C.

The bank loan officer or mortgage broker gives the loan details to the borrower 116C.

The loan originator (bank or mortgage broker) then assigns a loan number and type 118C. The loan application includes a verification of particular borrower background data including, but not limited to, credit check and employment verification for which the consumer/borrower executes the necessary releases.

At this stage, the consumer/borrower is introduced 120H to the system and method for asset identification, evaluation and control, including generation of the borrower data key and pass code, and the borrower is provided with review of security policies in place to protect the privacy rights of the future payer. For the review benefit of the consumer, any release forms include the language from the Non-Disclosure Document that will be signed by all parties privileged to review the data file. The consumer also signs a release for a future appraisal on the property, such as a 2055 Drive-by Appraisal (non invasive), for current valuation of the real estate that secures the Debt Instrument. The consumer also signs a release regarding running future title searches. Current title searches will be conducted on the property for evidence of any Deeds of Trust and any additional collateralized debt and liens to determine if any unknown encumbrances have been recorded on the underlying asset.

The borrower data key and pass code are provided by the loan originator 122C to the borrower 140B.

The loan originator provides the loan application hard packet 124C to the loan underwriter 142E.

The loan originator enters the loan number, loan type and borrower information into the loan file data library of the system and method for asset identification, evaluation and control where the information is categorized as loan file data 128H, and user file data 130H and a place holder is secured.

The system and method for asset identification, evaluation and control generates the borrower data key and pass code the system and method for asset identification, evaluation and control 132H, which are displayed to the loan originator 134H, and gives the user-ID, data key, and pass code to the borrower 136B.

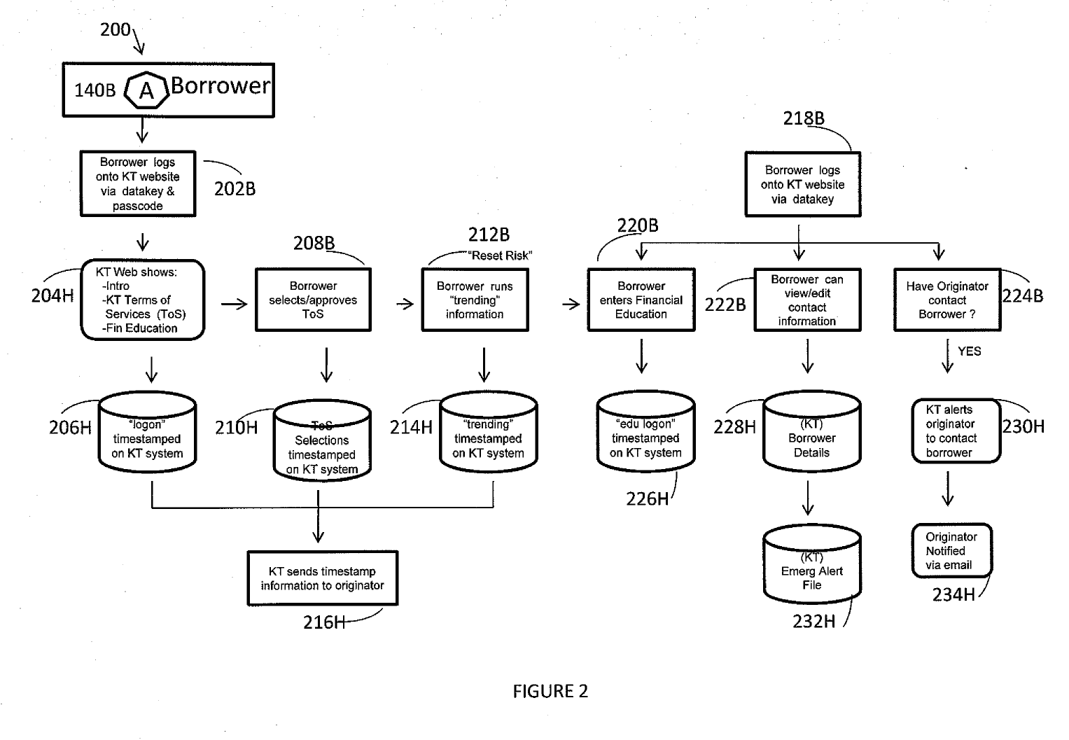

### Block Two: Borrower Processes Block 200 [FIG. 2]

The borrower 140B logs onto the website for the system and method for asset identification, evaluation and control using the data key and pass code 202B and the borrower logon is time/date stamped on the system 206H.

The website for the system and method for asset identification, evaluation and control provides the borrower with 1) introduction to the system/method; 2) Terms of Service; and 3) a financial education tutorial 204H.

The borrower selects/approves the Terms of Service 208B and the selections/approvals are time/date stamped on the system 210H.

The borrower runs “trending” information 2128 and the trending information is time/date stamped on the system 214H.

The system/method sends time/date stamp information, 206H, 210H, and 214H to the loan originator 216H.

The borrower enters the financial education tutorial 220B during the logon 2026, or by separate logon using the data key 218B, and the logon to the tutorial is time/date stamped on the system 226H.

The borrower can view, edit or update contact information 222B in the data library 228H of the system/method during the logon 202B, or by separate logon using the data key 218B. Changes to the contact information 222B in the data library 228H generate an emergency alert data file 232H in the data library 228H of the system/method.

The borrower can request the loan originator to contact the borrower 224B during the logon 202B, or by separate logon using the data key 218B, and the system/method alerts the loan originator of the borrowers request 230H and a confirming e-mail correspondence is sent to the loan originator 234H.

### Block Three Underwriter Processes Block 300 [FIG. 3]

The underwriter 142E receives the loan documentation hard packet 302E.

The loan documentation hard packet is scanned into the underwriter's own data system 304E and stored in the underwriter's data library 306E. This loan documentation includes without limitation: 1) the borrower's tax returns; 2) credit reports on the borrower; 3) the borrower's bank statements; 4) W2 or related tax reporting forms for the borrower; 5) employment verification for the borrower; 6) completed loan application forms for the borrower; and 7) the standard loan qualifying and performance terms.

The underwriter logs onto the system and method for asset identification, evaluation and control 308E and the scanned loan documents are uploaded 310E to the system and method for asset identification, evaluation and control, and stored in the loan document library 312H of the system and method for asset identification, evaluation and control.

The system and method for asset identification, evaluation and control validates the scanned documents uploaded into its loan document library for red flag items such as tax numbers, font changes, and the like 314H. Any red flag items are identified 336H with internal alerts to the operations function of the system and method for asset identification, evaluation and control 338H and a message to the underwriter of all red flag items found 340H. The data library for the system and method for asset identification, evaluation and control is updated with all red flags found 342H.

The underwriter completes all loan information 316E, providing such loan information to the data library of system and method for asset identification, evaluation and control 326H.

The system and method for asset identification, evaluation and control provides the loan information received from the underwriter to the audit function of the system and method for asset identification, evaluation and control 344H.

The underwriter draws up title documents with the promissory note 318E, scans the title documents and note and provides a digital set to the system and method for asset identification, evaluation and control 320H and sends the hard packet of title documents and note to the title company 322E with confirming communication to the system and method for asset identification, evaluation and control 324E.

The title documents and note are affixed with an electronic barcode 328H and sent to the data library 326H for the system and method for asset identification, evaluation and control and the underwriter 330H.

The system and method for asset identification, evaluation and control updates the loan status with the title company 332H and includes the electronic barcode in the loan information data within the data library of the system and method for asset identification, evaluation and control 334H.

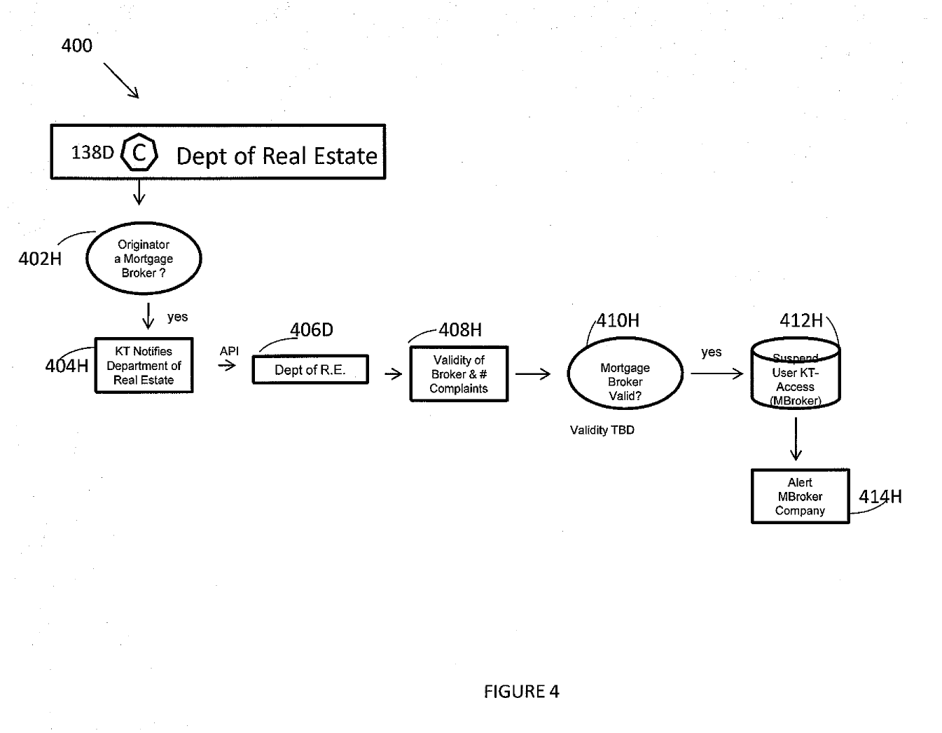

### Block Four Department of Real Estate Processes 400 [FIG. 4]

If the loan originator is a mortgage broker 402H, the system and method for asset identification, evaluation and control notifies 404H the department of real estate 406D.

The validity of the mortgage broker and number of consumer complaints 408H is determined 410H and access to the system and method for asset identification, evaluation and control is suspended, if necessary, 412H with an alert sent to the mortgage broker company 414H.

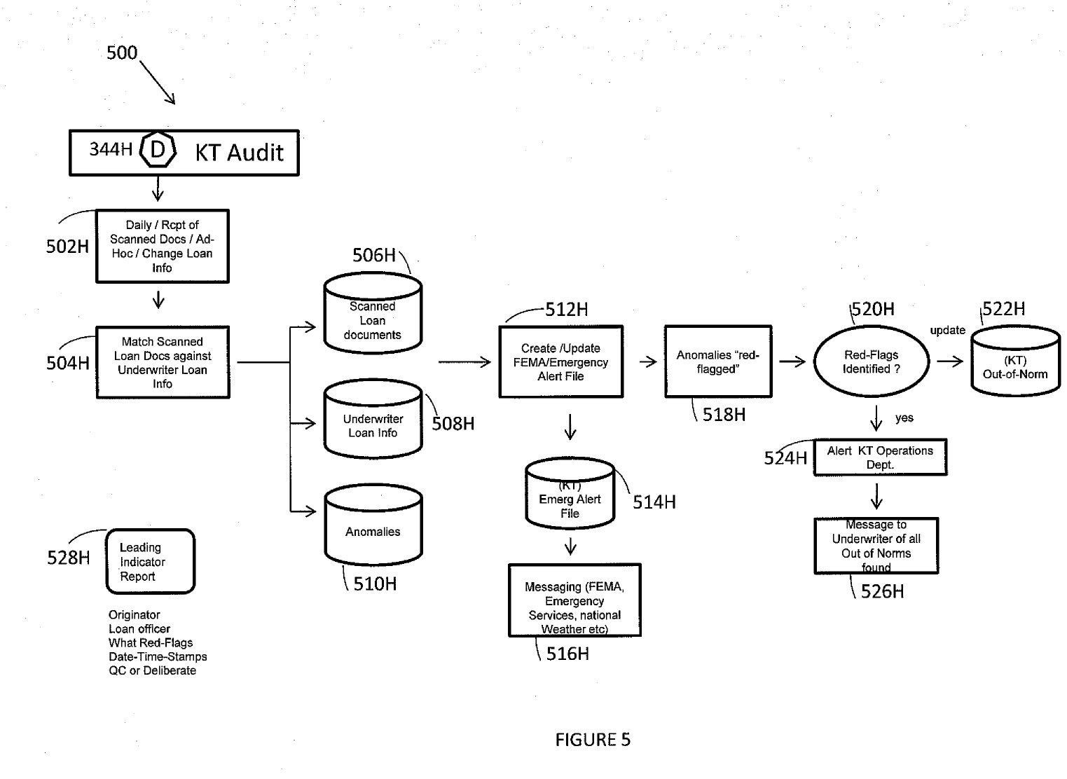

### Block Five: Audit Processes 500 [FIG. 5]

The audit process 344H for the system and method for asset identification, evaluation and control includes a daily receipt of scanned documents, routine and changed loan documents 502H. These documents

Each scanned loan document 506H is matched 504H against underwriter loan information 508H and anomalies are recorded 510H.

A FEMA emergency alert file is created/updated 512H stored in the data library of system and method for asset identification, evaluation and control 514H with emergency messaging sent using the appropriate system 516H.

Anomalies are red flagged 518H and identified 520H with out-of-norm updates sent to the data library of system and method for asset identification, evaluation and control 522H, and alerts to the operations function of the data library of system and method for asset identification, evaluation and control 524H with a message to the underwriter of all anomalies found 526H.

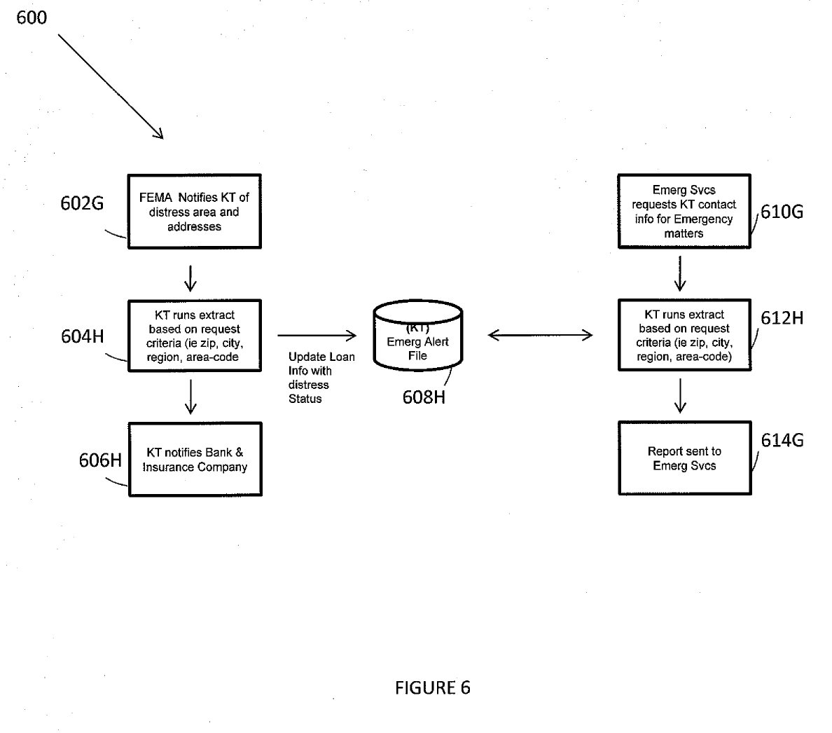

### Block Six: Emergency Services and Notifications 600 [FIG. 6]

FEMA notifies the system and method for asset identification, evaluation and control of distressed areas/addresses 602G or requests contact 610G.

The system and method for asset identification, evaluation and control runs an extract based on request or notification criteria 604H, 612H and updates the emergency alert data library of system and method for asset identification, evaluation and control 608H.

The corresponding bank/insurance company is notified for each effected loan 606H and a report is provided emergency services 614G.

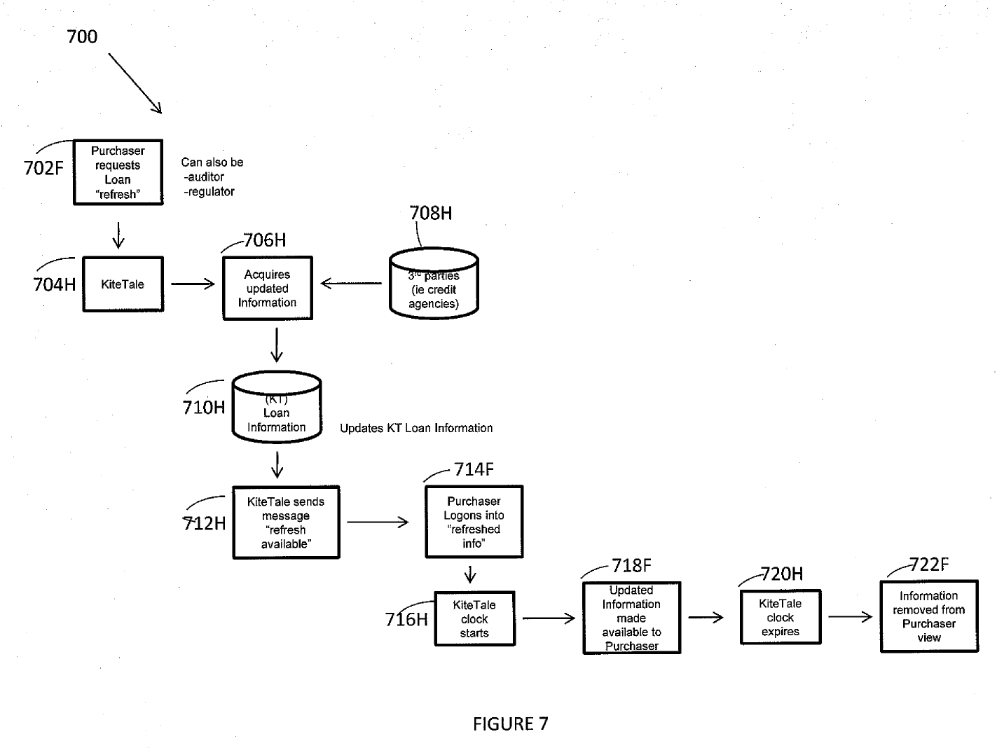

### Block Seven Loan Information Refresh 700 [FIG. 7]

A loan request is initiated 702F with the system and method for asset identification, evaluation and control 704H which acquires updated information 706H from third parties, such as credit agencies, 708H.

The loan information data library for of system and method for asset identification, evaluation and control is updated 710H and a refresh available message is provided to the requester 712H.

The requester logon to the refreshed information 714F, starting a predetermined, finite time window within the information data library for of system and method for asset identification, evaluation and control 716H.

During the time window, the updated information is made available to the purchaser 718F.

Once the time window expires 720H, the information is removed from the requester's view 722F.

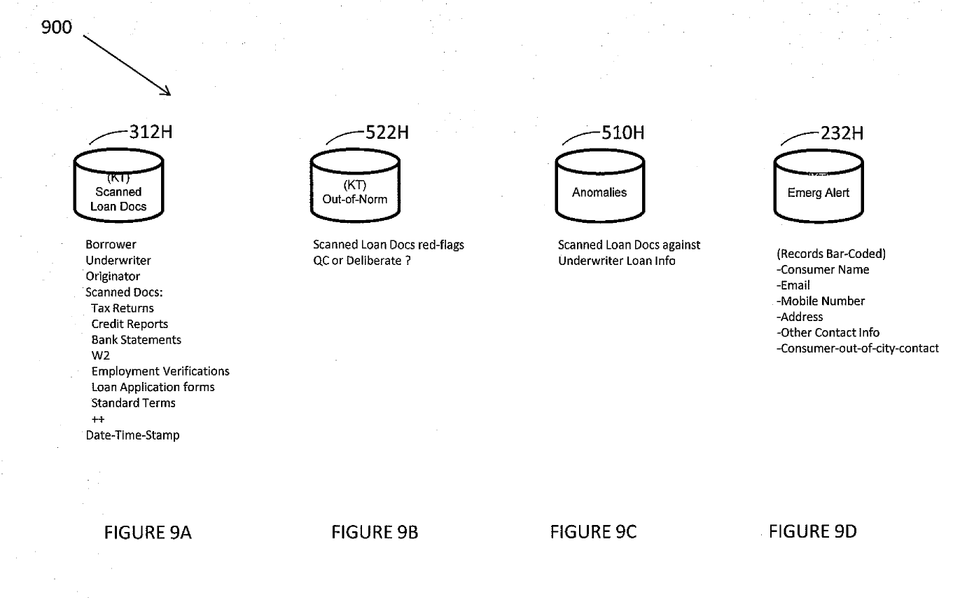

### Blocks Eight/Nine: Loan Information Library [FIGS. 8-9]

The barcoded records data file 326H within the loan information library of the method and system for asset identification, evaluation and control includes, without limitation: 1) Insurance-Information (company, contact, effective-date, Insurance Company Contact Name, Insurance Company Contact Address, Insurance Company Contact Phone, Insurance Company Contact Email, Date Insurance Effective, and Date Insurance Expires); 2) Timestamp Reset-Risk-executed; 3) Title Information and Title Company; and 4) Service-Record (Effective-Rate, Date Balance, Payment-Date, Interest-Paid-Thru-Date, First-of-Month-Amt, First-of-month-Date, Escrow-Payment, Loan-Effective-Date, and Loan-Unique-Id), FIG. 8A.

The loan information data file of the loan information library of the method and system for asset identification, evaluation and control 326H further includes, without limitation: 1) Borrower Name; 2) Unique-Barcode-Id; 3) User Data Key; 4) User Pass Code; 5) Time-Stamp (date-time-identity); 6) Loan Information; 7) Loan Number; 8) Loan Type (multi options drop down); 9) Loan Originator-Identification; 10) Current Loan-Status in Process; 11) Loan-Term; 12) Loan-Expiration-Date; 12) Buy Information; 13) Buy-price; 14) Buy-date; and 15) Buyer Name, FIG. 8A.

The loan status data file 710H of the information library of the method and system for asset identification, evaluation and control includes, without limitation: 1) Loan Status Code; 2) Loan Status Description; 3) Information Addition Date/Time; and 4) Information Addition Identity, FIG. 8B.

The terms of service data file 210H of the information library of the method and system for asset identification, evaluation and control includes, without limitation: 1) Term of Service Code; 2) Term of Service Description; 3) Information Addition Date/Time; and 4) Information Addition Identity, FIG. 8C.

The scanned loan documents data file 312H of the information library of the method and system for asset identification, evaluation and control includes, without limitation: 1) Borrower Identification; 2) Underwriter Identification; 3) Originator Identification; 4) Scanned Docs: a) Tax Returns; b) Credit Reports; c) Bank Statements; d) W-2 forms; e) Employment Verifications; f) Loan Application forms; g) Standard Loan Terms; and h) Date-Time-Stamp records, FIG. 9A.

The out-of-norm loan documents data file 522H of the information library of the method and system for asset identification, evaluation and control includes, without limitation: 1) Scanned Loan Documents red-flags; and 2) Whether the red-flags are Quality Control or Deliberate, FIG. 9B.

The anomalies data file 510H of the information library of the method and system for asset identification, evaluation and control includes, without limitation, scanned loan documents compared to underwriter loan information, FIG. 9C.

The emergency alert data file 232H of the information library of the method and system for asset identification, evaluation and control includes, without limitation, the following bar-coded records: 1) Consumer Name; 2) Customer Email Address; 3) Customer Mobile Telephone Number; 4) Customer U.S. Postal Address; 5) Other Customer Contact Information; and 6) Customer out-of-city-contact, FIG. 9D.

Accordingly, a process for asset identification, evaluation and control, in which financial information containing 1) the credit worthiness of a payer on a debt instrument, 2) current valuation of an asset to which the debt instrument is collateralized, and 3) a revalidation of title for the asset as necessary for secondary market financing, trading and asset valuation is disclosed. The process provides an updatable data set that is encrypted in combination with information not found in the data set to generate a control access identity. The control access identity is provided on selected data set items together with the selected information.

The process for asset identification, evaluation and control includes digitally formatting an encrypted updatable data set basis from an updatable data set hard copy with (i) an encryption key, plus (ii) a data key. These two keys both (i) are generated through an algorithm based on “secret key” and/or “public key” cryptography; (ii) are converted to a barcode printed on one or more updatable data set hard copies; and (iii) employ private encryption keys whose circulation is restricted to one or minimal persons on a need to know basis.

The process for asset identification, evaluation and control further includes reading the selected information from the digitally formatted and encrypted updatable data set and securing the digitally formatted and encrypted updatable data set. The selected information is then validated according to set parameters relating to the digitally formatted and encrypted updatable data set, decrypted, updated with the date, time and user for each update identified, re-encrypted, and re-secured. Encryption, decryption, updating and re-encryption of the updatable data set uses a secret key process using a private key.

The process for asset identification, evaluation and control further provides: (i) secured participating third party users with notification of changes to the digitally formatted updatable data set; (ii) secured participating third party users with notification of variations from set parameters relating to the digitally formatted updatable data set; (iii) non-secured, non-participating third party user input of critical changes to the digitally formatted updatable data set; and (iv) a non-disclosure updatable data set for underwriter and auditor review.

As disclosed generally herein, the embodiment of system and method for asset identification, evaluation and control for financial information containing the credit worthiness of a payer on a debt instrument, current valuation of an asset to which the debt instrument is collateralized, and a revalidation of title for the asset as necessary for secondary market financing, trading and asset valuation is a tool designed to unwind the current economic debacle by adding transparency to the troubled asset inventory, allowing for current valuation and redistribution into the marketplace. The system and method allows troubled assets to be extracted, updated and valued (per discretion of client's analytics methodology preference) at current valuations and managed separately from healthy assets. The system and method assists rating agencies to enhance their ability to improve their methodologies for accurately evaluating and rating securitized debt obligations. In this manner, the system and method provides data to assist in establishing a value floor for collateralized debt obligation contents destined for auction. Further, regulators and auditors in the global financial services marketplace can use the system and method as an oversight tool. Finally, the system and method serves as an information platform to aid in decision making for prospective purchasers of rehabilitated mortgages.

The disclosed system and method for asset identification, evaluation and control for financial information containing the credit worthiness of a payer on a debt instrument, current valuation of an asset to which the debt instrument is collateralized, and a revalidation of title for the asset as necessary for secondary market financing, trading and asset valuation supports new governmental accounting standards in at least one of the following respects: 1) reforming the loan origination and oversight process by both educating customers on their respective financial product as well as having verified, secure, clean data included into the data vault; 2) supporting the reform of the loan origination and oversight process, capturing loan and underwriting data at the origination, authenticating market participants and dynamically updating data for surveillance of true and accurate value pricing until repayment; 3) allowing all lending institutions to participate in the surveillance of their common interest to dynamically track other liens to collateral that supports the primary loan, which provides necessary information for true value of the underlying collateral; 4) adding transparency to the troubled asset inventory, allowing for current valuation and redistribution into the marketplace; 5) bridging and informational gap between lenders and the secondary marketplace by having the updated and refreshed data on the collateral of the loans and secured financial instruments; 6) enhancing regulator and auditor of ability in the global financial services marketplace to examine and catalog troubled assets that devalue institutional portfolios, whereby those troubled assets can be then extracted and managed separately from healthy assets; 7) originating future collateralized mortgage obligations parallel to the system and method allowing for collection and storage into the securitized library, for which management and updating of underwriting data will ensure the safety, quality and viability of debt instruments.

Finally, the disclosed system and method for asset identification, evaluation and control for financial information containing the credit worthiness of a payer on a debt instrument, current valuation of an asset to which the debt instrument is collateralized, and a revalidation of title for the asset as necessary for secondary market financing, trading and asset valuation supports proposed legislation for regulatory reform of the OTC derivatives market in at least one of the following respects: 1) providing a neutral contract mediation environment for use by the credit default swap marketplace or OTC derivatives, further providing for constructive support to the marketplace by participants in that arena; 2) storing of all information delineated in participating contracts (standard as well as customized), including all counterparties and all terms stored into a securitized environment, combined with updating of the valuation data of the underlying collateralized debt obligation for timely and accurate information to subscribers without excessive government intervention; 3) providing a centralized, securitized library holding CDO valuation data, and, thus, minimizing exposure related risk by securing such data in a neutral, third-party environment to be accessed by qualified participants in the analytics or exchange; 4) tracking the legal contracts and counterparties (including novational contracts) as they trade and travel through the global CDS market place; 5) parsing posted contracts for highly litigious and/or conflicting language that may be embedded therein prior to ratification and notifying participating parties for such language amendment opportunities; 6) initiating “contract triggers” to notify one or more contracting parties when certain market events are aggregation events occur, for the purpose of counterparties surveillance; 7) providing an electronic witness, date/time/intent stamp to deter, deflect, and mitigate litigation; 8) matching outstanding novation of counterparty contracts that require support in reestablishing counterparty surveillance within the environment to fulfill contract terms or renegotiate based upon new CDO valuations; and 9) coordinating with the client's selected clearinghouse to promote market efficiency, price transparency and value transparency, while maintaining client confidentiality (via encryption of critical, select information) in the OTC derivatives marketplace.

The system and method for exception based management of dynamic events are disclosed generally in terms of disclosed embodiments. It will be appreciated further that the system may vary as to configuration and as to the details of the parts, and that the method of using the system may vary as to details and to the order of steps, without departing from the basic concepts as disclosed herein. The system and method for asset identification, evaluation and control are disclosed generally in terms of providing a secure and private record of the credit worthiness of the payer on a debt instrument, current valuation of the asset to which the debt instrument is collateralized, and the revalidation of title attached to the debt instrument. Accordingly, the disclosed systems and methods may be used in a large variety of management and control applications, as will be readily apparent to those skilled in the art.

1. A process for asset identification, evaluation and control, in which selected information for an updatable data set is encrypted in combination with information not found in the data set to generate a control access identity provided on selected data set items together with the selected information, the process comprising:
a) digitally formatting an encrypted updatable data set from an updatable data set hard copy;
b) reading the selected information from the digitally formatted and encrypted updatable data set;
c) securing the digitally formatted and encrypted updatable data set;
d) validating the selected information according to set parameters relating to the digitally formatted and encrypted updatable data set;
e) decrypting the control access identity to obtain decrypted selected information from the digitally formatted and encrypted updatable data set;
f) updating the selected information from the digitally formatted and encrypted updatable data set;
g) re-encrypting the updated selected information; and
h) re-securing the digitally formatted and re-encrypted updatable data set.

2. A process according to claim 1, wherein the selected information for an updatable data set is encrypted with (i) an encryption key, plus (ii) a data key, both of which:
a) are generated through an algorithm based on “secret key” and/or “public key” cryptography;
b) are converted to a barcode; and
c) employ private encryption keys whose circulation is restricted to one or minimal persons on a need to know basis.

3. A process according to claim 2, wherein the digitally formatted updatable data set is encrypted, decrypted, updated and re-encrypted using a secret key process using a private key.

4. A process according to claim 2, wherein the barcode is printed on one or more updatable data set hard copies.

5. A process according to claim 1, further comprising identifying each update to selected information by date of update, time of update, and user providing the update.

6. A process according to claim 1, wherein the updatable data set comprises financial information containing the credit worthiness of a payer on a debt instrument, current valuation of an asset to which the debt instrument is collateralized, and a revalidation of title for the asset as necessary for secondary market financing, trading and asset valuation.

7. A process according to claim 1, further comprising notifying secured participating third party users of changes to the digitally formatted updatable data set.

8. A process according to claim 1, further comprising notifying secured participating third party users of variations from set parameters relating to the digitally formatted updatable data set.

9. A process according to claim 1, further comprising receiving from non-secured, non-participating third party users critical changes to the digitally formatted updatable data set.

10. A process according to claim 1, further comprising providing a non-disclosure process for updatable data set review by underwriters and auditors.

11. A process for asset identification, evaluation and control, in which financial information containing the credit worthiness of a payer on a debt instrument, current valuation of an asset to which the debt instrument is collateralized, and a revalidation of title for the asset as necessary for secondary market financing, trading and asset valuation for an updatable data set is encrypted in combination with information not found in the data set to generate a control access identity which is provided on selected data set items together with the selected information, the process comprising:
a) digitally formatting an encrypted updatable data set basis from an updatable data set hard copy with (i) an encryption key, plus (ii) a data key, both of which: (i) are generated through an algorithm based on “secret key” and/or “public key” cryptography; (ii) are converted to a barcode printed on one or more updatable data set hard copies; and (iii) employ private encryption keys whose circulation is restricted to one or minimal persons on a need to know basis;
b) reading the selected information from the digitally formatted and encrypted updatable data set;
c) securing the digitally formatted and encrypted updatable data set;
d) validating the selected information according to set parameters relating to the digitally formatted and encrypted updatable data set;
e) decrypting the control access identity to obtain decrypted selected information from the digitally formatted and encrypted updatable data set;
f) updating the selected information from the digitally formatted and encrypted updatable data set;
g) identifying the date, time and user for each update to the selected information;
h) re-encrypting the updated selected information; and
i) re-securing the digitally formatted and re-encrypted updatable data set;
wherein (i) the digitally formatted updatable data set is encrypted, decrypted, updated and re-encrypted using a secret key process using a private key, (ii) secured participating third party users are notified of changes to the digitally formatted updatable data set, (iii) secured participating third party users are notified of variations from set parameters relating to the digitally formatted updatable data set, (iv) non-secured, non-participating third party users provide critical changes to the digitally formatted updatable data set, and (v) underwriters and auditors review a non-disclosure updatable data set.

12. A system for asset identification, evaluation and control, in which selected information for an updatable data set is encrypted in combination with information not found in the data set to generate a control access identity provided on selected data set items together with the selected information, the system comprising:
a) a scanner for reading the selected information for an updatable data set; from an updatable data set hard copy; and
b) a data processing device programmed to (i) digitally format an encrypted updatable data set from an updatable data set hard copy, (ii) read the selected information from the digitally formatted and encrypted updatable data set, (iii) secure the digitally formatted and encrypted updatable data set, (iv) decrypt the control access identity to obtain decrypted selected information from the digitally formatted and encrypted updatable data set, (v) validate the selected information according to set parameters relating to the updatable data set, (vi) update the selected information from the digitally formatted and encrypted updatable data set, (vii) re-encrypt the updated selected information, and (viii) re-secure the digitally formatted and re-encrypted updatable data set.

13. A system according to claim 12, further comprising programmable data processing means for encrypting the selected information for an updatable data set with (i) an encryption key, plus (ii) a data key, both of which:
a) are generated through an algorithm based on “secret key” and/or “public key” cryptography;
b) are converted to a barcode; and
c) employ private encryption keys whose circulation is restricted to one or minimal persons on a need to know basis.

14. A system according to claim 13, wherein the digitally formatted updatable data set is encrypted, decrypted, updated and re-encrypted using a secret key process using a private key.

15. A system according to claim 14, further comprising means for printing the barcode on at least one updatable data set hard copy.

16. A system according to claim 12, further comprising programmable data processing means to identify each update to selected information by date of update, time of update, and user providing the update.

17. A system according to claim 12, wherein the updatable data set comprises financial information containing the credit worthiness of a payer on a debt instrument, current valuation of an asset to which the debt instrument is collateralized, and a revalidation of title for the asset as necessary for secondary market financing, trading and asset valuation.

18. A system according to claim 12, further comprising telecommunications means for notifying secured participating third party users of changes to the digitally formatted updatable data set.

19. A system according to claim 12, further comprising telecommunications means for notifying secured participating third party users of variations from set parameters relating to the digitally formatted updatable data set.

20. A system according to claim 12, further comprising telecommunication means for receiving from non-secured, non-participating third party users critical changes to the digitally formatted updatable data set.

21. A system according to claim 12, further comprising a telecommunications means for providing a non-disclosure review of the updatable data set by underwriters and auditors.

22. A system for asset identification, evaluation and control, in which selected information for financial information containing (i) the credit worthiness of a payer on a debt instrument, (ii) current valuation of an asset to which the debt instrument is collateralized, (iii) and a revalidation of title for the asset as necessary for secondary market financing, trading and asset valuation as an updatable data set encrypted in combination with information not found in the data set to generate a control access identity which is provided on selected data set items together with the selected information, the system comprising:
a) a scanner for reading the selected information for an updatable data set from an updatable data set hard copy;
b) means for encrypting the selected information for an updatable data set with (i) a barcode printed on one or more updatable data set hard copies; and (iii) employ private encryption keys whose circulation is restricted to one or minimal persons on a need to know basis;
c) a data processing device programmed to (i) digitally format an encrypted digitally formatted and encrypted updatable data set, (iv) decrypt the control access identity to obtain decrypted selected information from the digitally formatted and encrypted updatable data set, (v) validate the selected information according to set parameters relating to the updatable data set, (vi) update the selected information from the digitally formatted and encrypted updatable data set, (vii) identify each update by date, time and user identity, (viii) re-encrypt the updated selected information, and (ix) re-secure the digitally formatted and re-encrypted updatable data set;
d) telecommunications means for notifying secured participating third party users of changes to the digitally formatted updatable data set;
e) telecommunications means for notifying secured participating third party users of variations from set parameters relating to the digitally formatted updatable data set;
f) telecommunication means for receiving critical changes to the digitally formatted updatable data set from non-secured, non-participating third party users; and
g) telecommunications means for providing a non-disclosure review of the updatable data set by underwriters and auditors;
wherein the digitally formatted updatable data set is encrypted, decrypted, updated and re-encrypted using a secret key process using a private key.
